(19) United States
(12) Patent Application Publication
(10) Pub. No.: US 2008/0314888 A1
(43) Pub. Date: Dec. 25, 2008

(54) Sealing mechanism for hand-held electric sealer

(76) Inventor: Richard Chang, Hsi Chih City (JP)

Correspondence Address: BACON & THOMAS, PLLC, 625 SLATERS LANE, FOURTH FLOOR, ALEXANDRIA, VA, 22314-1176, US

(21) Appl. No.: 12/003,531

(22) Filed: Dec. 28, 2007

(30) Foreign Application Priority Data
Jun. 23, 2007 (TW) 096122738

(51) Int. Cl. H05B 1/00; B65B 51/10

(52) U.S. Cl. 219/240; 219/243

(57) ABSTRACT

An improved sealing mechanism includes a heat insulation base, a heating portion, and a compression spring, where the heat insulation base has a left side part, a middle part, and a right side part. The heating portion includes at least two heating wires equidistantly spaced from each other a certain distance, a left locating plate and a right locating plate, where the heating wires are, at both ends, electrically connected with the left locating plate and the right locating plate, respectively. The left locating plate and the right locating plate of the heating portion are engaged with the left side part and the right side part of the heat insulation base, respectively, such that the heating wires are positioned at the middle part of the heat insulation base.

### BACKGROUND OF THE INVENTION

1. Field of the Invention

The present invention relates to an improved sealing mechanism for hand-held electric sealer, and more particularly, to a hand-held electric sealer with an improved sealing mechanism having multiple heating wires so as to enhance sealing reliability and durability.

2. Description of Related Art

Nowadays there are several kinds of hand-held electric sealers available in the market. Generally, a conventional hand-held electric sealer comprises a casing, a sealing mechanism, and a press bar. The sealing mechanism includes a heating wire which, after energized by electric power, will be heated sufficiently for sealing plastic bags.

The conventional hand-held electrical sealers achieve the sealing purpose on plastic bags with a single heating wire which produces a single sealing score. However, the plastic bags under a single sealing score may lack sealing reliability, particularly when sealed plastic bags are delivered with carelessness and suffered from an impact. Under such circumstances, even if the plastic bags are sealed tightly, the sealing may be broken apart due to the impact on the plastic bags, resulting in falling away of the goods inside the bags.

### SUMMARY OF THE INVENTION

An object of the present invention is to provide an improved sealing mechanism for hand-held electric sealer, so that multiple sealing scores can be made on plastic bags for assuring sealing reliability and durability.

According to the present invention, the improved sealing mechanism for hand-held electric sealer comprises a casing, a sealing mechanism, and a press bar. The sealing mechanism includes a heat insulation base and a heating portion, where the heat insulation base has a left side part, a middle part, and a right side part, neighboring to one another sequentially.

The heating portion includes at least two heating wires equidistantly spaced from each other a certain distance, a left locating plate and a right locating plate, where the heating wires are, at both ends, electrically connected with the left locating plate and the right locating plate, respectively. The left locating plate and the right locating plate of the heating portion are engaged with the left side part and the right side part of the heat insulation base, respectively, such that the heating wires are positioned at the middle part of the heat insulation base.

By means of the above-mentioned improvement in design, the hand-held electric sealer, according to the present invention, provides at least two sealing scores on the plastic bags under sealing, so that the bags to be sealed can have a desirable reliability on the sealing even the sealed bags suffer from a working environment under impact.

According to the present invention, the left locating plate and the right locating plate have each a C-shaped cross section, and are engaged with the left side part and the right side part of the heat insulation base, respectively. Further, the left locating plate and the right locating plate of C-shaped cross section have each at least two positioning slots corresponding to the at least two heating wires, such that the heating wires can be inserted into and secured at the positioning slots conveniently and accurately.

In the present invention, the sealing mechanism further includes a compression spring disposed underneath the heat insulation base, so that the heat insulation base can move up and down against the casing. The heat insulation base may be made of ceramic material.

The left locating plate and the right locating plate of the heating portion may be rivets, and that the left side part and the right side part of the heat insulation base are each provided with a hole for receiving each corresponding rivet. The heating wires, at their ends, are each welded on the heads of the rivets, respectively. Alternatively, ends of the at least two heating wires can be fastened by the rivets in the holes of the left side part and the right side part of the heat insulation base.

The at least two heating wires may be covered with a heat resistant sheet, or heat resistant sheets may be laid both above and underneath the heating wires, where the heat resistant sheet(s) may be meshed fabric containing Teflon, or the like materials.

According to the present invention, the left locating element and the right locating element may be resilient elements. The left side part and the right side part of the heat insulation base are provided, respectively, with a hole, such that the resilient locating elements are resiliently extended and secured in the holes.

The heat insulation base is, at its middle part, provided with scotches, corresponding to the at least two heating wires, for positioning the heating wires.

The hand-held electric sealer, according to the present invention, can be powered by AC electricity; or by DC electricity through a transformer.

Other objects, advantages, and novel features of the present invention will become more apparent from the following detailed description when taken in conjunction with the accompanying drawings.

### BRIEF DESCRIPTION OF THE DRAWINGS

FIG. 1 shows an explosion view of an improved sealing mechanism for hand-held electric sealer according to a first embodiment of the present invention;

FIG. 2 shows an explosion view of an improved sealing mechanism according to a second embodiment of the present invention;

FIG. 3 shows an explosion view of an improved sealing mechanism according to a third embodiment of the present invention;

FIG. 4 shows a cross-sectional view of the improved sealing mechanism according to the third embodiment of the present invention;

FIG. 5 shows an explosion view of an improved sealing mechanism according to a fourth embodiment of the present invention;

FIG. 6 shows a cross-sectional view of part of the sealing mechanism according to the fourth embodiment of the present invention;

FIG. 7 shows an explosion view of an improved sealing mechanism according to a fifth embodiment of the present invention; and

FIG. 8 shows a cross-sectional view of part of the improved sealing mechanism according to the fifth embodiment of the present invention.

### DETAILED DESCRIPTION OF THE PREFERRED EMBODIMENTS

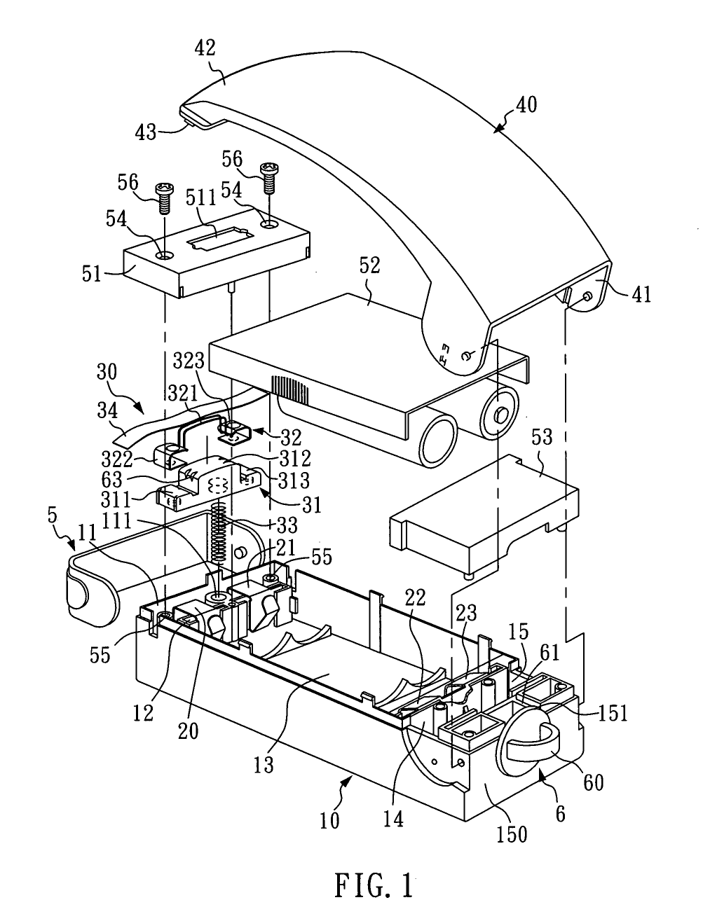

Referring to FIG. 1, an improved sealing mechanism for hand-held electric sealer according to a first embodiment the present invention comprises a casing 10, a sealing mechanism 30, and a press bar 40. The casing 10 includes a front chamber 11, a front contact holder 12, a battery chamber 13, a rear contact holder 14, and a rear chamber 15. The front chamber 11 is provided with a spring holder 111; a pair of front metal contacts 20, 21 are disposed on the front contact holder 12; and a pair of rear metal contacts 22, 23 are disposed on the rear contact holder 14, wherein the rear metal contacts 22, 23 are connected with each other.

The sealing mechanism 30 is disposed in the front chamber 11 of the casing 10, and includes a heat insulation base 31 of for example ceramic material, a heating portion 32, and a compression spring 33. The heat insulation base 31 has a left side part 311, a middle part 312, and a right side part 313, which are neighboring to one another sequentially. The compression spring 33 is disposed between the heat insulation base 31 and the spring holder 111, so that the heat insulation base 31 can move up and down against the casing 10. The middle part 312 has two scotches 63 for positioning two heating wires 321. The heating portion 32 includes the heating wires 321 which are parallel with, and equidistantly spaced from each other about 1 to 2 mm. The heating wires 321 are, at both ends, electrically connected with a left locating plate 322 and a right locating plate 323, respectively. The left locating plate 322 and the right locating plate 323 have each a C-shaped cross section, and are engaged with the left side part 311 and the right side part 313 of the heat insulation base 31, respectively, such that the heating wires 321 are positioned at the middle part 312 of the heat insulation base 31, and that the locating plates 322, 323 are electrically connected with the pair front metal contacts 20, 21 correspondingly.

The press bar 40 is, at one end 41, pivotally connected with one end of the casing 10, while is at another end 42 corresponds to the middle part 312 of the heat insulation base 31, so that when the press bar 40 is pressed down, a heat insulation block 43 located at the another end 42 of the press bar 40 will contact the middle part 312. A cover means is provided for covering the casing 10, where the cover means includes a front cover 51, a battery cover 52, and a rear cover 53, correspondingly covering the sealing mechanism 30, the battery chamber 13, and a rear portion of the casing 10. Both the casing 10 and the press bar 40 may be made of transparent plastics.

The front cover 51 has an opening 511 so that the middle part 312 of the heat insulation base 31 can extend therethrough. The front cover 51 has two thread holes 54 which correspond to the two thread holes 54 provided at two thread posts 55 in the front chamber 11, so that with two screws 56 passing through the thread holes 54 and engaged into the thread holes 54 of the thread posts 55, the front cover 51 can be secured to the casing 10.

In the present embodiment, a safety means 5 is also included. The safety means 5, located correspondingly to the sealing mechanism 30, has a U-shaped structure and is pivotally attached to the sides of the casing 10, such that the safety means 5 can turn to a position above the sealing mechanism 30 so as to prevent the press bar 40 from an unintentional pressing and sealing action.

Further, a hook 6 includes a hanging portion 60 and a fixing portion 61, where the fixing portion 61 is positioned in the rear chamber 15, and the hanging portion 60 extends outward from an opening 151 located at a rear surface 150 of the rear chamber 15.

The sealing mechanism 30 further includes a heat resistant sheet 34 which is covered on the middle part 312 and the heating portion 32. The heat resistant sheet 34 may be meshed fabric containing Teflon, or the like materials, so as to provide a smooth surface and to protect the heating portion 32.

When in use, the safety means 5 needs to be turned away from above the sealing mechanism 30, such that when the press bar 40 is pressed down, the heat insulation block 43 will contact the middle part 312, making the heating portion 32 energized by batteries loaded inside the battery chamber 13. Thereafter the two heating wires 321 are heated for sealing plastic bags.

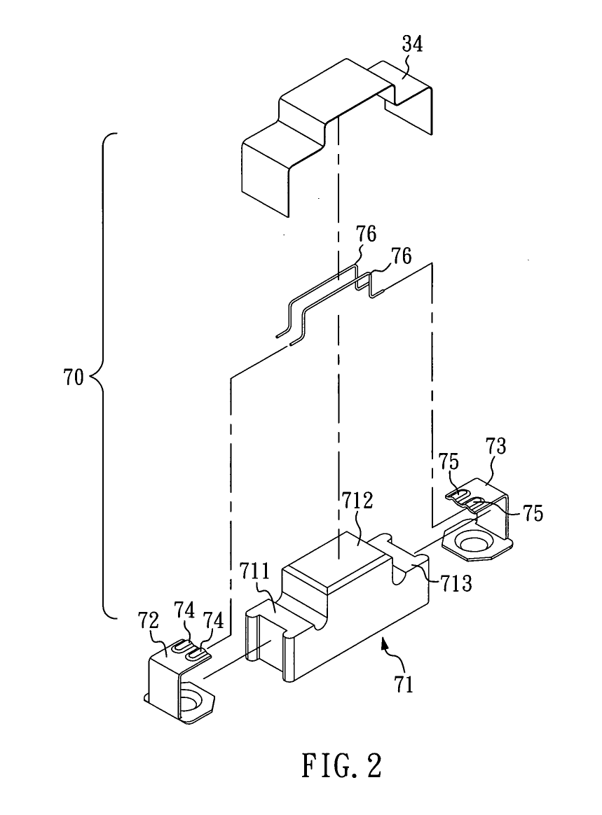

Referring to FIG. 2, an explosion view of an improved sealing mechanism according to a second embodiment of the present invention, a sealing mechanism 70 is generally similar to that of the first embodiment, except that two positioning slots 74, 75, corresponding to two heating wires 76, are provided at the left side part 711 and the right side part 713 of a heat insulation base 71. The heating wires 76 are inserted into and secured at the positioning slots 74, 75. Similarly, two locating plates 72, 73 are clamped on the left side part 711 and the right side part 713 of the heat insulation base 71. With the help of the positioning slots 74, 75, the heating wires 76 can be secured in position, though there are no scotches (as provided in the first embodiment) provided at a middle part 712 of the heat insulation base 71.

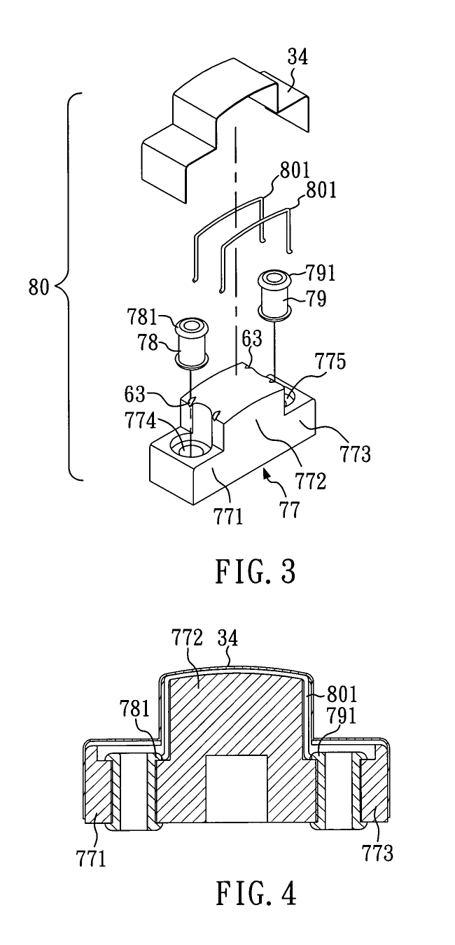

Referring to FIGS. 3 and 4, an explosion view and a cross-sectional view of an improved sealing mechanism according to a third embodiment of the present invention, a sealing mechanism 80 is generally similar to that of the first embodiment, except that two locating plates 78, 79 are rivets, with two heating wires 801 welded on rivet heads 781, 791, respectively. The two rivets 78, 79 extend through holes 774, 775 provided at the left side part 771 and the right side part 773 of a heat insulation base 77, such that the heating wires 801 can be positioned on the heat insulation base 77. Scotches 63 are also provided at a middle part 772 of the heat insulation base 77.

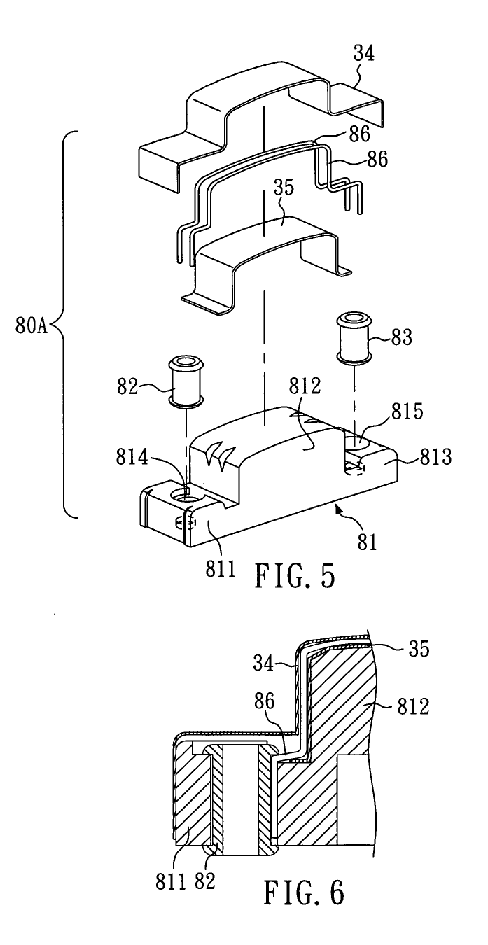

Now referring to FIGS. 5 and 6, an explosion view and a cross-sectional view of part of an improved sealing mechanism according to a fourth embodiment of the present invention, a sealing mechanism 80A is generally similar to that of the third embodiment, except that a left locating element 82 and a right locating element 83 are hollow rivets, with ends of two heating wires 86 fastened by the locating elements 82, 83 in the holes 814, 815 provided at a left side part 811 and a right side part 813 of a heat insulation base 81.

In the present embodiment, in addition to a heat resistant sheet 34 arranged above a middle part 812 of the heat insulation base 81, a heat resistant sheet 35 is laid underneath the heating wires 86 such that the heat resistant sheet 35 is interposed between the heating wires 86 and the middle part 812.

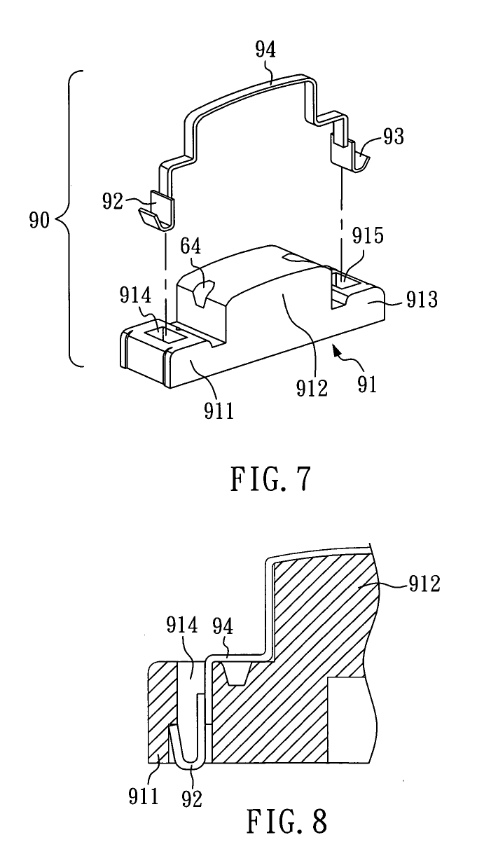

Further, referring to FIGS. 7 and 8, an explosion view and a cross-sectional view of part of an improved sealing mechanism according to a fifth embodiment of the present invention, a sealing mechanism 90 is generally similar to that of the first embodiment, except that a strap-like heating wire 94 is connected, at both ends thereof, respectively, a resilient left locating element 92 and a resilient right locating element 93. The left side part 911 and the right side part 913 of a heat insulation base 91 are provided, respectively, with a hole 914, 915, such that the resilient locating elements 92, 93 are resiliently extended and secured in the holes 914, 915. Scotches 64 of a greater dimension are provided at a middle part 912 of the heat insulation base 91 so as to fit the heating wire 94.

The design in the multi-heating wires, according to the present invention, not only fits a sealing mechanism which is integral with the hand-held electric sealer, but also a sealing mechanism which is detachable to the electric sealer.

Further, according to the present invention, with a single pressing action on the press bar, multiple sealing scores can be made on plastic bags, making the sealing have a better impact resistance. Besides, when the first sealing score breaks away, the second sealing score can serve as a spare so as to assure sealing reliability.

Although the present invention has been explained in relation to its preferred embodiments, it is to be understood that many other possible modifications and variations can be made without departing from the scope of the invention as hereinafter claimed.

What is claimed is:

1. An improved sealing mechanism for hand-held electric sealer, comprising:
a sealing mechanism, including a heat insulation base and a heating portion, where the heat insulation base includes a left side part, a middle part, and a right side part, neighboring to one another sequentially; and
characterized in that:
the heating portion includes at least two heating wires equidistantly spaced from each other a certain distance, a left locating plate and a right locating plate, where the heating wires are, at both ends, electrically connected with the left locating plate and the right locating plate, respectively, and the left locating plate and the right locating plate of the heating portion are engaged with the left side part and the right side part of the heat insulation base, respectively, such that the heating wires are positioned at the middle part of the heat insulation base.

2. The improved sealing mechanism for hand-held electric sealer as claimed in claim 1, wherein the left locating plate and the right locating plate have each a C-shaped cross section, and are engaged with the left side part and the right side part of the heat insulation base, respectively.

3. The improved sealing mechanism for hand-held electric sealer as claimed in claim 2, wherein the left locating plate and the right locating plate of C-shaped cross section have each at least two positioning slots, such that the at least two heating wires can be inserted into and secured at the positioning slots.

4. The improved sealing mechanism for hand-held electric sealer as claimed in claim 1, wherein the left locating plate and the right locating plate of the heating portion are rivets, and the left side part and the right side part of the heat insulation base are each provided with a hole for receiving each corresponding rivet.

5. The improved sealing mechanism for hand-held electric sealer as claimed in claim 4, wherein the at least two heating wires, at their ends, are each welded on the head of each corresponding rivet.

6. The improved sealing mechanism for hand-held electric sealer as claimed in claim 4, wherein ends of the at least two heating wires are fastened by the rivets in the holes of the left side part and the right side part of the heat insulation base.

7. The improved sealing mechanism for hand-held electric sealer as claimed in claim 1, wherein the at least two heating wires are covered with a heat resistant sheet.

8. The improved sealing mechanism for hand-held electric sealer as claimed in claim 7, wherein the heat resistant sheet contains Teflon.

9. The improved sealing mechanism for hand-held electric sealer as claimed in claim 7, wherein another heat resistant sheet is laid underneath the at least two heating wires.

10. The improved sealing mechanism for hand-held electric sealer as claimed in claim 9, wherein the heat resistant sheet and/or the another heat resistant sheet contains Teflon.

11. The improved sealing mechanism for hand-held electric sealer as claimed in claim 1, wherein the left locating element and the right locating element are resilient elements, and the left side part and the right side part of the heat insulation base are provided, respectively, with a hole, such that the resilient locating elements are resiliently extended and secured in the holes.

12. The improved sealing mechanism for hand-held electric sealer as claimed in claim 1, wherein the heat insulation base is, at its middle part, provided with scotches, corresponding to the heating wires, for positioning the at least two heating wires.

13. The improved sealing mechanism for hand-held electric sealer as claimed in claim 1, wherein the sealing mechanism further includes a compression spring disposed underneath the heat insulation base.

14. The improved sealing mechanism for hand-held electric sealer as claimed in claim 1, wherein the heat insulation base is made of ceramic material.
